(19) United States
(12) Patent Application Publication
(10) Pub. No.: US 2023/0090236 A1
(43) Pub. Date: Mar. 23, 2023

(54) VACUUM FORMED PARTS WITH CATALYTIC ENHANCEMENT

(71) Applicant: UNIFRAX I LLC, Tonawanda, NY (US)

(72) Inventors: Christopher Brook ROBINSON, Amherst, NY (US); Mauricio Munhoz DE SOUZA, Amherst, NY (US); Robert M. CRAVENS, Ypsilanti, MI (US)

(21) Appl. No.: 18/045,680

(22) Filed: Oct. 11, 2022

Related U.S. Application Data
(63) Continuation of application No. PCT/US2022/076791, filed on Sep. 21, 2022.
(60) Provisional application No. 63/247,481, filed on Sep. 23, 2021.

(51) Int. Cl. B01D 46/00; B01D 46/24; B01D 46/82

(52) U.S. Cl. CPC B01D 46/0001; B01D 46/2407; B01D 46/82

(57) ABSTRACT

A vacuum formed part includes at least two layers with one layer including a catalyst and the other not including a catalyst. At least one of the layers is formed by applying a slurry to a die or mold and applying a vacuum to the die or mold. The other layer may be formed from a slurry or may be provided onto the die or mold in the form of a fiber mat or blanket.

### CROSS REFERENCE TO RELATED APPLICATIONS

This application is a continuation of PCT International Patent Application No. PCT/US2022/076791 filed Sep. 21, 2022 and titled “VACUUM FORMED PARTS WITH CATALYTIC ENHANCEMENT”, which claims priority to U.S. Provisional Patent Application No. 63/247,481 filed Sep. 23, 2021 and titled “VACUUM FORMED PARTS WITH CATALYTIC ENHANCEMENT”, which are hereby incorporated by reference in their entirety.

### FIELD OF THE DISCLOSURE

The present disclosure relates to vacuum formed parts with catalytic enhancement. More particularly, the disclosure related to vacuum formed parts having one or more fiber-containing layers wherein at least one layer includes a catalyst.

### BACKGROUND

Vacuum formed parts may be used in a variety of applications and industries. For example, candle filters may be vacuum formed. Candle filters are used for filtration of hot gases from the exhaust system in glass furnaces, cement industries, steel plants, and others. Similar to a baghouse filter, candle filters are placed vertically inside a filter box. Hot gases are introduced inside the filter box and the exiting cleaned gas is released to the atmosphere.

The hot gases normally contain particulate matter that gets trapped on the outside surface of the candle filter. As the gas travels through the wall thickness of the candle filter, the particulate matter is retained, and the gas exits clean of particles. In some cases, the stack gas also contains high level of NOx, SOx, dioxins and other pollutants that cannot be released to the atmosphere. In those cases, a catalytic candle filter is required. The catalytic layer has the function of cleaning the stack gas from these pollutants. Catalytic candle filters may be produced by spraying a candle filter with a catalytic solution. The catalytic liquid infuses inside the walls of the candle filter, thereby impregnating it. For example, WO 2017/055344 A1, which is incorporated herein by reference in its entirety, describes one technique of impregnating a vacuum formed candle filter with a catalytic liquor in order to obtain a catalytic candle filter. One of the problems with this approach, however, is the high cost of the final product as it requires a secondary post treatment of the candle filter once it is ready in order to transform it in a catalytic filter.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. Embodiments are described in detail hereinafter with reference to the accompanying figures, in which:

FIG. 1 is a vacuum formed part according to an embodiment of the present disclosure;

FIG. 2 is a schematic diagram of a method of forming a vacuum formed part according to an embodiment of the present disclosure;

FIG. 3 is a schematic diagram of another method of forming a vacuum formed part according to an embodiment of the present disclosure;

FIG. 4 is a vacuum formed part according to another embodiment of the present disclosure;

FIG. 5 is a schematic diagram of another method of forming a vacuum formed part according to an embodiment of the present disclosure; and

FIG. 6 is a schematic diagram of another method of forming a vacuum formed part according to an embodiment of the present disclosure.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The present disclosure is directed to methods of producing composite vacuum formed parts that incorporates a catalytic layer together with a non-catalytic layer. Vacuum formed parts are materials produced when a dispersion of fiber and binder (herein also referred to as a “slurry”) is formed into a final product shape by applying a vacuum in a porous die or mold. In particular, the die or mold is submerged in the slurry and vacuum in applied. By doing so, a layer of fiber and binder is deposited in the mold cavity and a part that mirrors the die shape in then obtained. An unlimited number of shapes (sleeves, blocks, cones, filter candles, etc.) and formulations (low density, high density, low temperature, high temperature, etc.) can be obtained.

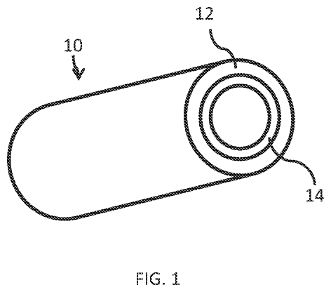

With reference to FIG. 1, the vacuum formed part 10 includes at least two layers 12, 14, wherein one of the layers 12, 14 is a layer of fiber and binder as disclosed above and the other of the layers 12, 14 is a catalytic layer comprising a catalyst. In some embodiments, the catalyst may include one or more platinum group metals (PGM), one or more transition metals or oxides thereof, such as vanadia or titania, or combinations thereof. In some embodiments, the catalytic layer is an outer layer 12 and the inner layer 14 is non-catalytic (i.e., does not contain a catalyst). In other embodiments, the inner layer 14 is the catalytic layer and the outer layer 12 is non-catalytic. Each of the inner layer 14 and the outer layer 12 may comprise fibers, wherein the fibers in each layer 12, 14 may be the same or different. Additionally, each of the layers 12, 14 may comprise one or more binder. The materials (binder, fibers, catalysts, additives, etc.) may be similar to those disclosed in U.S. Patent Application Publication Nos. 2017/0341004A1 and 2017/0320013A1, which are incorporated herein by reference in their entireties. In some embodiments, the fibers include inorganic fibers selected from high alumina polycrystalline fibers, refractory ceramic fibers such as alumina-silicate (aluminosilicate) fibers, alumina-magnesia-silica fibers, kaolin fibers, calcium aluminate fibers, alkaline earth silicate fibers such as calcia-magnesia-silica fibers or magnesia-silica fibers, S-glass fibers, S2-glass fibers, E-glass fibers, quartz fibers, silica fibers or combinations thereof.

In some embodiments, the binder includes a colloidal metal (for example, silica, alumina, titania, zinc, magnesia, zirconia, or combinations thereof), clay, or combinations thereof. In some embodiments, the clay may be calcined or uncalcined, and may include but not be limited to attapulgite, ball clay, bentonite, hectorite, kaolinite, kyanite, montmorillonite, palygorskite, saponite, sepiolite, sillimanite, or combinations thereof.

In some embodiments, any slurry described herein may include one or more additives. For example, in some embodiments, any slurry may include a flocculating agent, such as cationic starch, acrylic latex, polyvinyl chloride, polyvinyl alcohol, polyacrylamide, or combinations thereof. In some embodiments, any slurry may include an organic filler or an inorganic filler. In some embodiments, any slurry may include a hardening agent.

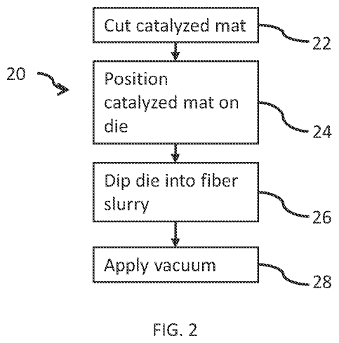

Turning to FIG. 2, the present disclosure provides a method 20 of producing a composite vacuum formed part that contains a non-catalytic layer of fiber and binder as well as a catalytic layer further comprising a catalyst that will impart a catalytic function to that given layer. In a step 22, a catalytic layer is provided by, e.g., cutting a catalyzed mat to an appropriate size and shape. In some embodiments, the catalytic layer may be a fiber blanket or a fiber mat that has a catalyst incorporated therein. In step 24, the catalytic layer is positioned on a die or in a mold. In step 26, the die or mold, including the catalytic layer, is dipped into a slurry comprising fiber and binder, which may be as described above. In step 28, a vacuum is applied to provide the vacuum formed part.

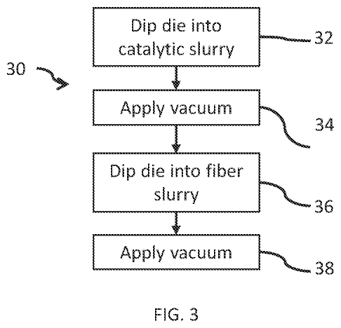

With reference to FIG. 3, in another embodiment, the vacuum formed part is formed by method 30. The method 30 includes a step 32 of dipping the die or mold into a slurry comprising a catalyst, fiber, and binder, which may be as described above. In step 34, a vacuum is applied to the die, thereby forming a catalytic layer on the die. In step 36, the die, including the catalytic layer thereon, is dipped into a slurry of fiber and binder, which may be as described above. Lastly, in step 38, a vacuum is applied to provide the vacuum formed part having a non-catalytic layer formed on a catalytic layer. In some embodiments, steps 32 and 36 may be switched. In some embodiments, steps 32 and 34 and/or step 36 and 38 may be repeated as desired to form any number of catalytic and non-catalytic layers in any order.

Using the techniques described herein, it is possible to control the thickness of the catalytic layer (by changing the thickness of the original catalytic layer) and the thickness of the non-catalytic layer by controlling the immersion time with a given slurry concentration and/or by modifying the composition and/or properties (such as viscosity) of the slurry.

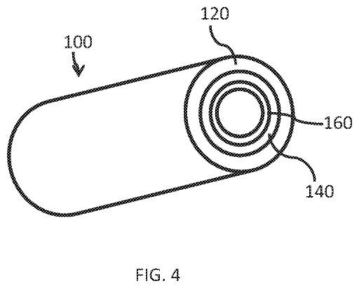

Referring to FIG. 4, in another embodiment, a vacuum formed part 100 includes three layers: an outer layer 120, an intermediate layer 140, and an inner layer 160. The layers 120, 140, 160 may be the same as those described above, wherein at least one of the layers 120, 140, 160 is a catalytic layer. In some embodiments, the intermediate layer 140 is a catalytic layer and each of the inner layer 160 and the outer layer 120 are non-catalytic layers. In other embodiments, the inner layer 160 and the outer layer 120 are each catalytic layers that may be the same or different and the intermediate layer 140 is a non-catalytic layer.

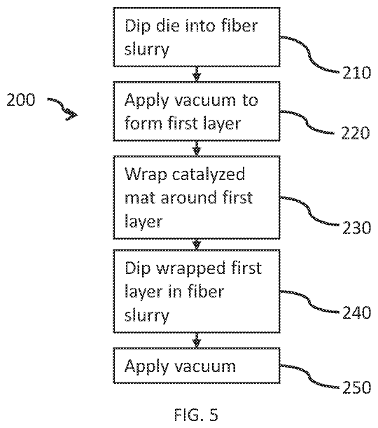

With reference to FIG. 5, a method 200 of forming a vacuum formed part is described. Namely, in step 210, a die or mold is dipped into a first slurry comprising fiber and binder. In step 220, a vacuum is applied to form a first, non-catalytic layer. In step 230, a catalyzed mat or blanket, which has been cut to the appropriate size and shape, is applied around the first layer. Next, in step 240, the wrapped die is again dipped into the first slurry. Alternatively, the wrapped die may be dipped into a second, non-catalytic slurry that is different from the first slurry. Finally, in step 250, a vacuum is applied to the die to produce the composite vacuum formed part. The method 200 may be modified such that one or both of the first and second slurries is a catalytic slurry and/or wherein the mat or blanket employed in step 230 is non-catalytic.

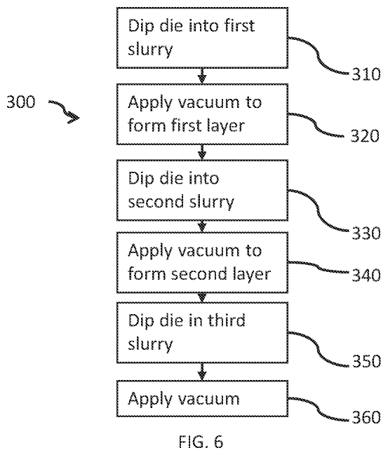

Turning to FIG. 6, in another method 300, a vacuum formed part is formed by first, in a step 310, dipping a die or mold into a first slurry. Next, in step 320, a vacuum is applied to form a first layer. In step 330, the die, having the first layer formed thereon, is dipped into a second slurry and, in a step 340, a vacuum is applied to form a second layer on the first layer. Next, in step 350, the die, having the first and second layers formed thereon, is dipped into a third slurry and a vacuum is applied in a final step 360. Each of the slurries used in steps 310, 330, and 350 may be catalytic or non-catalytic provided that at least one slurry is non-catalytic and at least one slurry is catalytic.

The techniques described herein prove to be very flexible in terms of where the catalytic layer can be placed. Great flexibility is also possible in terms of the composition, density, porosity, permeability, etc. of the non-catalytic layer. The present techniques have the advantage that there is no need to pre-impregnate a blanket/mat with the catalytic element to be used to wrap or to be inserted in the mold. By simply having two tanks with the two different mixes and then vacuum forming the layers, the placement of the catalytic layer may be easily tailored. Similarly, the densities, thickness, permeability, etc. of each layer may be tailored by adjusting the respective slurry formulations.

By using the methods described in this disclosure, a catalytic candle filter can be obtained in one or more vacuum forming steps without need of any secondary post treatment. Another advantage is the ability to control the permeability, density, porosity and pressure drop of the catalytic layer in order to obtain a maximum efficacy during the catalysis process. A wide variety of shapes and formats can be produced by the methods of the present disclosure in a way that it will expand the possibilities for novel and engineered product forms for any application that requires catalysis.

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. A method of forming a vacuum formed part, comprising:
applying a mat onto a die, wherein the mat comprises first fibers and a catalyst;
dipping the mat and die into a first slurry comprising second fibers, which are of the same or a different type than the first fibers, and a binder; and
applying a vacuum to the die to form the vacuum formed part.

2. The method of claim 1, wherein the die comprises a first layer onto which the mat is applied; and
wherein the first layer is formed by dipping the die into a second slurry, which is the same or different from the first slurry, and applying a vacuum to the die.

3. The method of claim 2, wherein the first slurry is different from the second slurry.

4. The method of claim 3, wherein the second slurry comprises third fibers having a different composition than the second fibers of the first slurry.

5. The method of claim 1, wherein the catalyst comprises a platinum group metal, a transition metal, a transition metal oxide, or combinations thereof.

6. The method of claim 1, wherein the first fibers and the second fibers comprise inorganic fibers comprising silica and/or alumina.

7. The method of claim 1, wherein the binder comprises colloidal silica.

8. The method of claim 2, wherein at least one of the first slurry or the second slurry comprises a flocculating agent.

9. The method of claim 8, wherein the flocculating agent comprises cationic starch, acrylic latex, polyvinyl chloride, polyvinyl alcohol, polyacrylamide, or combinations thereof.

10. The method of claim 2, wherein at least one of the first slurry or the second slurry does not comprise a catalyst.

11. A vacuum formed part produced by the method of claim 1.

12. A method of forming a vacuum formed part, comprising:
dipping a die into a first slurry comprising a plurality of first fibers and a first binder;
applying a vacuum to the die to form a first layer thereon;
dipping the die and the first layer into a second slurry comprising a plurality of second fibers and a second binder; and
applying a vacuum to the die to form the vacuum formed part;
wherein the plurality of first fibers is the same or different from the plurality of second fibers;
wherein the first binder is the same or different from the second binder; and
wherein one of the first slurry and the second slurry comprises a catalyst and the other of the first slurry and the second slurry does not comprise a catalyst.

13. The method of claim 12, wherein the first fibers and the second fibers comprise inorganic fibers.

14. The method of claim 12, wherein the binder comprises a colloidal metal.

15. The method of claim 12, further comprising dipping the die and vacuum formed part into a third slurry comprising a plurality of third fibers and a third binder; and
applying a vacuum to the die.

16. The method of claim 12, wherein the plurality of first fibers is different from the plurality of second fibers; and/or
wherein the first binder is different from the second binder.

17. The method of claim 15, wherein the plurality of third fibers is different from the plurality of first fibers or the plurality of second fibers.

18. The method of claim 15, wherein the first slurry and the third slurry do not comprise a catalyst and the second slurry comprises a catalyst.

19. The method of claim 15, wherein the first slurry and the third slurry comprise a catalyst and the second slurry does not comprise a catalyst.

20. A vacuum formed part produced by the method of claim 12.
